(19) United States
(12) Patent Application Publication
(10) Pub. No.: US 2004/0141472 A1
(43) Pub. Date: Jul. 22, 2004

(54) Wireless LAN

(76) Inventor: Wassim Haddad, Verdun Municipality (CA)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/697,962

(22) Filed: Oct. 31, 2003

(30) Foreign Application Priority Data
Jan. 16, 2003 (GB) 0300951.1

(51) Int. Cl. H04B 7/00

(52) U.S. Cl. 370/310

(57) ABSTRACT

A wireless LAN comprises an access point and plural mobile communications devices requiring data communication with the access point. A controller at the access point controls the supply of data communication to the mobile communications devices. The controller sets up a peer-to-peer connection between a first mobile communications device already receiving a data communication supplying a given service and a second mobile communications device requiring that service.

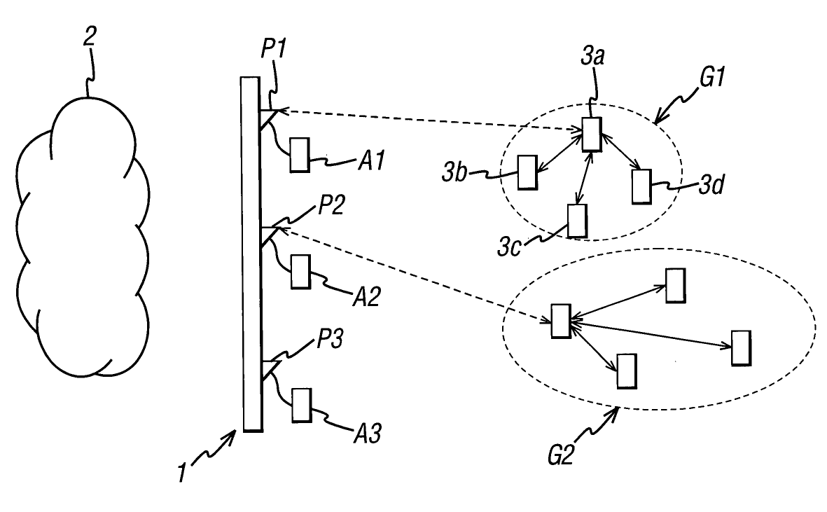

### CROSS-REFERENCE TO RELATED APPLICATIONS

Not Applicable

### STATEMENT REGARDING FEDERALLY FUNDED RESEARCH OR DEVELOPMENT

Not Applicable

### INCORPORATION BY REFERENCE OF MATERIAL SUBMITTED ON COMPACT DIS

Not Applicable

### BACKGROUND OF THE INVENTION

1. Technical Field

This invention relates to a wireless local area network (LAN), and in particular to a method of, and apparatus for, increasing the quality of service (QoS) in a wireless LAN.

2. Background Art

A wireless LAN can use any one of a number of known wireless technologies, such as 802.11a, 802.11b, Hiperlan/2, Bluetooth or Home RF. The choice of technology used depends on a number of parameters. Where, however, QoS is an important factor, it is usual to use 802.11a. Hiperlan/2 would be the preferred choice of wireless technology, but this technology is currently unavailable. Some of these different technologies operate at 5 GHz (e.g 802.11a), and some operate at 2.4 GHz (e.g 802.11b), and each operates at a different rate.

In a communications system, such as one operating using any one of the wireless technologies mentioned above, a hot spot is an area of high bandwidth connectivity, that is to say an area in which high bandwidth connections can be made. Clearly, the QoS in a hot spot will depend upon the bandwidth of the access point providing service, the number of users requiring service, and their QoS requirements. Generally speaking, there are three clases of service—class A (best quality) which requires a large bandwidth, class B (good quality) which requires a medium bandwidth, and class C (poor quality) which requires a lower bandwidth. Clearly, where an access point is providing class A service to a number of users, there is a danger that the entire bandwidth of that access point will be used, in which case any additional user entering the hot spot will receive no service. Alternatively, the QoS of each of the original users will be reduced to accommodate the new user.

An aim of the invention is to increase the QoS of a wireless LAN, particularly in a hot spot.

### SUMMARY OF THE INVENTION

The present invention provides a wireless LAN comprising an access point, a plurality of mobile communications devices requiring data communication with the access point, and a controller for controlling the supply of data communication to the mobile communications devices, the controller being such as to set up a peer-to-peer connection between a first mobile communications device already receiving a data communication supplying a given service and a second mobile communications device requiring that service.

In a preferred embodiment, a software agent associated with the access point constitutes the controller.

Advantageously, the access point includes plural wireless technologies for data communication with mobile communications devices, and preferably the wireless technologies include 802.11a, 802.11b, Hiperlan/2, Bluetooth and Home RF. In this case, the software agent may be such as to provide data communications to a given mobile communication device using a wireless technology appropriate to the QoS required by that mobile communications device.

Preferably, the controller is such as to control the peer-to-peer connection between the first and second mobile communications devices so as to provide the second mobile communications device with the given service from the first mobile communications device using a wireless technology appropriate to the QoS required by the second mobile communications device.

In a preferred embodiment, the controller is such as to register the second mobile communications device with a Session Initiation Protocol (SIP) server associated with the access point by providing that device with an SIP address, whereby that device can subsequently set up the peer-to-peer connection with the first mobile communications device using SIP messages.

The invention also provides a method of increasing the QoS of a wireless LAN comprising an access point and a plurality of mobile communications devices, the method comprising the steps of:

a) providing data communications from the access point to a plurality of mobile communications devices at a respective QoS requested by each mobile communications device until the transmission bandwidth ceiling of the access point is reached; and

b) setting up a peer-to-peer connection from one of the said mobile communications devices to an additional mobile communications device requesting a data communication providing the same service as that provided to said one mobile communications device by the access point.

Preferably, step b) is such that the additional mobile communications device receives said data communication from said one mobile communications device at a QoS requested by the additional mobile communications device or at the highest QoS available from said one mobile communications device.

Advantageously, the access includes plural wireless technologies for data communication with mobile communications devices, the method further comprising the step of choosing the appropriate wireless technology for data communications from the access point to the mobile communications devices for the QoS requested by said devices. Conveniently, each of the mobile communications devices includes plural wireless technologies for data communication, the method further comprising the step of selecting the best wireless technology for a peer-to-peer connection from a given one of the said mobile communications devices to the additional mobile communications device in dependence upon the QoS requested by said additional mobile communications device.

In a preferred embodiment, the method further comprises the step of registering said additional mobile communications device with an SIP server associated with the access point so that said additional mobile communications device is supplied with an SIP address, the provision of the SIP address enabling communication between the additional mobile communications device and the SIP server and between the additional mobile communications device and said one mobile communications device in order to set up the peer-to-peer connection between said two mobile communications devices.

Preferably, communication between said mobile communication devices in setting up the peer-to-peer connection is conducted using SIP messages. Advantageously, registration of said additional mobile communications device with the SIP server is achieved using DHCP.

### BRIEF DESCRIPTION OF THE DRAWINGS

The invention will now be described in greater detail, by way of example, with reference to the drawing, the single figure of which is a schematic representation of a wireless LAN constructed in accordance with the invention.

### DETAILED DESCRIPTION OF THE DRAWINGS

Referring to the drawing, a service provider network 1 includes three access points P1, P2 and P3 which are hard wired together. The service provider network 1 is connected to the Internet 2 by any suitable interface (not shown). Each of the access points P1, P2 and P3 acts as a service provider for groups of users, such as the groups G1 and G2 associated with the access points P1 and P2. Where each of the groups G1 and G2 requires high bandwidth connectivity, a hot spot is created. Each of the users has a mobile communications device such as a laptop computer, a personal digital assistant (PDA) or a 2G/3G mobile phone enabled with one or more of the wireless technologies mentioned above.

Each of the access points P1 to P3 includes means for data communication using each of the wireless technologies 802.11a, 802.11b, Hiperlan/2, Bluetooth and Home RF. Accordingly, each of the access points P1 to P3 can communicate with the mobile communications device having any of these wireless technologies.

In a simple wireless LAN of the type shown in the drawing, each of the access points P1 to P3 may have a bandwidth which can supply only one user with class A service. If a user having a mobile communications device 3a in the group G1 requires class A service, for example to watch a football match transmission available from a service provider, that user will take all the bandwidth of the access point P1. Accordingly, other users having mobile communications devices 3b, 3c and 3d within the group G1 are unable to receive service from the access point P1 unless the QoS supplied to the user of the device 3a is reduced.

The wireless LAN of the invention overcomes this difficulty by providing a software agent A1, A2 and A3 at each of the access points P1, P2 and P3. Thus, the software agent A1 is configured to set up a peer-to-peer (P2P) connection between the device 3a and one or more of the devices 3b to 3d, so that the same service can be supplied to the or each of those devices. This P2P connection can be initiated by each of the devices 3b to 3d using the session initiation protocol (SIP). Any mobile device entering the network served by the access point P1 is registered with an associated local SIP server (not shown), which allocates the device an SIP address that is used for communicating with the device whilst in the network. Registration is achieved using Dynamic Host Configuration Protocol (DHCP), and the SIP server and the mobile device can then exchange SIP messages which comprise an address header and a text field. The text field is used to identify the services required by that mobile device, and to set up P2P connection between that device and any other device in the network using the wireless technology available between those devices. Communication between mobile devices in setting up a P2P connection will also be conducted using SIP messages.

SIP is preferred because it operates at the application level of the system, and supports instant messaging using the text field of SIP messages. Therefore, the invention, in controlling the supply of data as between the access points P1 to P3 and the mobile devices, can be application specific, and can be made rapidly responsive to user requests. P2P connections between mobile devices can, therefore, be set up seamlessly.

Where only a single one of the devices 3b to 3d requires the service, this can be supplied to each at class A service. On the other hand, if all three of the devices 3b to 3d require the service, the service is supplied at a lower class of service, thereby providing the service to those devices at a lower QoS. In this way, the access point P1 provides service to a greater number of users than would be the case if service had to be provided directly to each of the users. Any suitable wireless technology can be used for P2P connections, though Hiperlan/2 is preferred when high QoS is required by an additional user. In many cases, however, Bluetooth is the preferred wireless technology. It is also possible for an additional user to access say the device 3a via the mobile communications device of an intermediate user not wanting the service provided to the device 3a, using a short-range wireless technology such as Bluetooth.

The software agent A1 is configured for charging for services provided. For example, if the device 3b requires the same service supplied to the device 3a, the software agent sets up a charging procedure which charges the user of the device 3b with two charges, one to the service provider of the service, and the other to the user of the device 3a. In practice, this latter charge can be effected by reducing the charge made by the service provider to the user of the device 3a.

This fanning out of service provision could be further enhanced by using a “second tier” device such as the device 3b to provide service to a further device (not shown). In this case, the further device uses SIP to contact the access point P1 which then initiates P2P communication from the device 3b to the additional device. In this connection, it should be noted that any mobile communications device entering the network served by the access point P1 is supplied with an SIP address. The software agent A1 can then monitor the network supplied by the access point P1 to ascertain the load on the main network, and the load on each mobile communications device being used to transmit a service supplied thereto by the access point to an additional mobile communications device.

In a practical wireless LAN of this type, each of the access points P1 to P3 has a bandwidth considerably in excess of that necessary to supply a single user with class A service, and so can provide high QoS to a plurality of users. Each of those users could be supplied with a different service, so that additional users requiring any one of those services could be provided with that service via the user originally supplied with that service.

Obviously, where the access point P1 is operating at maximum bandwidth, service can only be provided to new users via an existing user if the service required by that new user is one already being provided to an existing user.

The service agents A1 to A3 are configured to provide services on the wireless technology best suited to the QoS required by any given user. For high QoS requirements, 802.11a is normally used, though 802.11b may be preferred where conservation of battery power of the user is an important factor. As mentioned above, Hiperlan/2, if available, is the preferred choice of wireless technology.

The wireless LAN of the invention ensures that both a service provider and users asking for a high QoS can benefit from other users asking for lower classes of QoS. Moreover, the wireless LAN of the invention permits a substantial increase in the number of users that can be serviced. Thus, the service provider can supervise the available bandwidth for direct users, and to offer new connections, when needed, to other users, by establishing P2P sessions between direct users and those other users. This enables a service provider to become more competitive by attracting more users, whilst optimising the bandwidth and the variation of class of QoS provided.

1. A wireless LAN comprising an access point, a plurality of mobile communications devices requiring data communication with the access point, and a controller for controlling the supply of data communication to the mobile communications devices, the controller being such as to set up a peer-to-peer connection between a first mobile communications device already receiving a data communication supplying a given service and a second mobile communications device requiring that service.

2. A wireless LAN as claimed in claim 1, wherein the controller includes a software agent associated with the access point.

3. A wireless LAN as claimed in claim 1, wherein the access point includes a plurality of wireless technologies for data communication with mobile communications devices.

4. A wireless LAN as claimed in claim 3, wherein the wireless technologies include 802.11a, 802.11b, Hiperlan/2, Bluetooth and Home RF.

5. A wireless LAN as claimed in claim 3, wherein the software agent is such as to provide data communications to a given mobile communication device using a wireless technology appropriate to the QoS required by that mobile communications device.

6. A wireless LAN as claimed in claim 1, wherein the controller is such as to control the peer-to-peer connection between the first and second mobile communications devices so as to provide the second mobile communications device with the given service from the first mobile communications device using a wireless technology appropriate to the QoS required by the second mobile communications device.

7. A wireless LAN as claimed in claim 6, wherein the controller is such as to register the second mobile communications device with an SIP server associated with the access point by providing that device with an SIP address, whereby that device can subsequently set up the peer-to-peer connection with the first mobile communications device using SIP messages.

8. A method of increasing the QoS of a wireless LAN having an access point and a plurality of mobile communications devices, the method comprising the steps of:
a) providing data communications from the access point to a plurality of mobile communications devices at a respective QoS requested by each mobile communications device until the transmission bandwidth ceiling of the access point is reached; and
b) then setting up a peer-to-peer connection from one of the said mobile communications devices to an additional mobile communications device requesting a data communication providing the same service as that provided to said one mobile communications device by the access point.

9. A method as claimed in claim 8, wherein step b) is such that the additional mobile communications device receives said data communication from said one mobile communications device at a QoS requested by the additional mobile communications device or at the highest QoS available from said one mobile communications device.

10. A method as claimed in claim 8, wherein the access point includes plural wireless technologies for data communication with mobile communications devices, the method further comprising the step of choosing the appropriate wireless technology for data communications from the access point to the mobile communications devices for the QoS requested by said devices.

11. A method as claimed in claim 10, wherein each of the mobile communications devices includes plural wireless technologies for data communication, the method further comprising the step of selecting the best wireless technology for a peer-to-peer connection from a given one of the said mobile communications device to the additional mobile communications devices in dependence upon the QoS requested by said additional mobile communications device.

12. A method as claimed in claim 8, further comprising the step of registering said additional mobile communications device with an SIP server associated with the access point so that said additional mobile communications device is supplied with an SIP address, the provision of the SIP address enabling communication between the additional mobile communications device and the SIP server and between the additional mobile communications device and said one mobile communications device to set up the peer-to-peer connection between said two mobile communications devices.

13. A method as claimed in claim 12, wherein communication between said mobile communication devices in setting up the peer-to-peer connection is conducted using SIP messages.

14. A method as claimed in claim 12, wherein registration of said additional mobile communications device with the SIP server is achieved using DHCP.

15. A wireless LAN comprising an access point, a plurality of mobile communications devices requiring data communication with the access point, and a controller for controlling the supply of data communication to the mobile communications devices, the controller being arranged to set up a peer-to-peer connection between a first mobile communications device for receiving a data communication supplying a given service and a second mobile communications device requiring that service.

16. A wireless LAN comprising an access point, a plurality of mobile communications devices requiring data communication with the access point, and a controller for controlling the supply of data communication to the mobile communications devices, the controller being such as to set up a peer-to-peer connection between a first mobile communications device for already receiving a data communication supplying a given service and a second mobile communications device requiring that service, wherein the controller includes a software agent associated with the access point, and wherein the controller is such as to control the peer-to-peer connection between the first and second mobile communications devices so as to provide the second mobile communications device with the given service from the first mobile communications device using a wireless technology appropriate to the QoS required by the second mobile communications device.

17. A method of increasing the QoS of a wireless LAN having an access point and a plurality of mobile communications devices, the method comprising the steps of:
a) providing data communication from the access point to plural mobile communications devices at a respective QoS requested by each mobile communications device until the transmission bandwidth ceiling of the access point is reached; and
b) setting up a peer-to-peer connection from one of said mobile communications devices to an additional mobile communications device requesting a data communication providing the same service as that provided to said one mobile communications device by the access point, said peer-to-peer connection being such that the additional mobile communications device receives said data communication from said one mobile communications device at a QoS requested by the additional mobile communications device or at the highest QoS available from said one mobile communications device.

18. A method of increasing the QoS of a wireless LAN comprising an access point and plural mobile communications devices, the method comprising the steps of:
a) providing data communication from the access point to plural mobile communications devices at a respective QoS requested by each mobile communications device until the transmission bandwidth ceiling of the access point is reached; and
b) setting up a peer-to-peer connection from one of the said mobile communications devices to an additional mobile communications device requesting a data communication providing the same service as that provided to said one mobile communications device by the access point; wherein each of the mobile communications devices includes plural wireless technologies for data communication, and the method further comprises the step of selecting the best wireless technology for said peer-to-peer connection in dependence upon the QoS requested by said additional mobile communications device.

19. A method of increasing the QoS of a wireless LAN having an access point and plural mobile communications devices, the method comprising the steps of:
a) providing data communications from the access point to a plurality of mobile communications devices at a respective QoS requested by each mobile communications device until the transmission bandwidth ceiling of the access point is reached;
b) then setting up a peer-to-peer connection from one of the said mobile communications devices to an additional mobile communications device requesting a data communication providing the same service as that provided to said one mobile communications device by the access point; and
c) registering said additional mobile communications device with an SIP server associated with the access point so that said additional mobile communications device is supplied with an SIP address, the provision of the SIP address enabling communication between the additional mobile communications device and the SIP server and between the additional mobile communications device and said one mobile communications device to set up the peer-to-peer connection between said two mobile communications devices.
